(19) United States
(12) Patent Application Publication
(10) Pub. No.: US 2017/0091407 A1
(43) Pub. Date: Mar. 30, 2017

(54) Trumold

(71) Applicants: Quincy Gonzalez, Bronx, NY (US); Lamont Brown, Bronx, NY (US)

(72) Inventors: Quincy Gonzalez, Bronx, NY (US); Lamont Brown, Bronx, NY (US)

(21) Appl. No.: 15/159,640

(22) Filed: Jun. 17, 2016

Related U.S. Application Data
(60) Provisional application No. 62/284,241, filed on Sep. 24, 2015.

(51) Int. Cl. G06F 19/00

(52) U.S. Cl. CPC G06F 19/3418

(57) ABSTRACT

This is a product/application that allows you, the consumer, to connect with personal trainers anywhere you are based on your geographical location. The product/application allows you to set your personal physical targets and goals. After the personal setup, you will be able to search your location for the personal trainer of your choosing based on the trainer's profile and user reviews of said trainers. After choosing your personal trainer, you will receive a response from your chosen trainer within three hours of selecting them; which will include a schedule session with location and length of time to confirm. Upon confirmation, your payment will be processed for the future scheduled appointment with your chosen trainer. The product/application will also allow you to create a community of like-minded individuals; be it family, friends, or found friends who are physically engaged like you are in an attempt to create your own community for inspiration and accountability. Once you, the user, registers their account, you will be able to see anyone in a geographical area to interact with in the context of your fitness targets and goals. You will be able to motivate each other through posts, emojis, shared practices, food suggestions, comments, etc.

### MOBILE APPLICATION

A Smartphone application will be developed for Booking Trainer, and it will be developed for the Users (Learners/Trainees) and Trainers. Users will be able to request a Trainer and track their fitness training Session, completion status etc. via the app. Trainers will receive requests from the Learners/Trainees, get directed to them and maintain the record of the sessions. Additionally, they will have capability of using the device GPS and Push notifications.

### Web Based Admin Panel

One web based admin panel will be developed for these types of users. The login credentials will authorize the roles of the users:
For Individual Trainers:
   A web based Admin panel will be developed to manage profile, rates and maintain a record of all the transaction that takes place between the trainee and the trainer.
Web Based Admin Panel For Company Trainers:
   A web based Admin panel will be developed to manage profile (for all Trainers under that Company), rates and maintain a record of all the transaction that takes place.
Web Based Super Admin Panel:
   A web based Super Admin panel will be developed to manage Learners/Trainees and Trainer and maintain a record of all the transaction that takes place.

### Stages of Project Development

### Wire Frames:

Detailed wire frames of each of the application screens and getting them approved by the client. The links for the wireframes are given as below:
Mobile Application For Trainees/Learners:
   https://collaborate.uxpin.com/b11682a68b12eef96da8eea7d14b8edb897dbd1a#/pages/53339455
Mobile Application For Trainers/TruMold Coaches:
   https://collaborate.uxpin.com/2dba26db6a9af0cf8adb2ded7ba757bff0246f75#/pages/53339671

### Design:

Our design house will create the app icon and UI designs for the app. The screens will be designed to support the relevant versions of iOS phones. We will provide 2-3 variations from which client could select one. We will provide some iteration for the selected icon/design based on client's feedback.

### Backend:

Database has to be designed and developed. Web services will be developed to take care of the content/status management and controlling the dynamics of the mobile app with the web based database.

### Frontend Coding:

We will share compiled builds for iOS as per the schedule defined in the milestones.

### Test Reports:

Our in house experienced QA engineers will test the app and provide a test report.

### Source Code:

We will assign all rights and provide all source code on completion of the project and receiving final payment.

### App Submission:

1. If you want us to submit the application on iTunes stores, we could do that, but that is not considered part of the scope, cost or schedule. This is a free additional service we provide with no liability.
2. Our offer does include the effort it may include to fix the app in case of rejection by iTunes app store—which may arise as a result of any technical/design issues within the scope of work as a result of our development and we will fix the issues and rebuild and update as required. For issues within the defined scope there will be no extra charge. But in case there is additional effort outside of the defined scope, then there will be a charge based on the effort required.
3. The schedule does not include the time it may require for this resubmission process.

### Support:

Our offer includes 90 days of free support post handover. Support includes issues that are related to the defined scope of work and relating to work that has been developed by us. These could include bugs, crashes and other errors in the app.

Post 90 days, incident based support could be provided—to be billed on an hourly basis.

### Supported Platforms

### 1. Target Platforms:

| Platform | Versions | Devices | Orientation |
|---|---|---|---|
| iOS | iOS 7-iOS 9 | iPhone 4S - 960 × 640 | Portrait |
| | | iPhone 5, 5C & 5S - 1136 × 640 | (only) |
| | | iPhone 6 - 1334 × 750 | |
| | | iPhone 6 PLUS - 1242 × 2208 | |
| | | iPod Touch 5G - 640 × 1136 | |

### 2. Mobile Application Development Platforms:

| Target Platform | Development platform |
|---|---|
| iOS | Native - Using Objective-C on Xcode. |

### 3. Web Server/Technology:

| | |
|---|---|
| Operating System | Linux |
| Web server | Apache |
| Open Source Technology | PHP 5.x |
| Framework | CodeIgniter/Cake/Custom PHP. |
| | (Depending on the requirement) |
| Frontend | HTML 5, CSS 3, JavaScript |
| Database | MySQL 5.x |
| Push notifications | Outgoing port 2195 needs to be enabled on the |
| | server for iOS. |

We can also develop backend systems on other platforms, but we will need to evaluate the requirement before we commit.

### Assumptions

Following assumptions have been taken:

### 1. Language:

The application will be in English language only.

### 2. Network Connection:

User will need internet connection to use this application.

### 3. App Type:

Please let us know if this will he a free app.

### Mobile Application Features

We will develop a single application that can be used by both Users (Learners/Trainees) and Trainers. There options will be provided to the Users where registering to the application.

a. Learners/Trainees

b. Trainers

The login credentials of the user will authorize and provide access to features relevant to the user as per role.

*Refer to “App for Trainers—Functional Requirements in MobileApplication” for functional aspects of the section. The Trainers will use the application to access the User's (Trainee's/Learner's) information and can confirm/decline appointment for a Session. Trainers will need to login from Trainer section in the application.

Provided below are the details of the features accessible to ‘Trainee/Learner’ Users:
1. App for Users (Learners/Trainees) Functional Requirements in Mobile Application:

a. Splash Screen:
After downloading and entering the application Users will get a Splash Screen with application title and logo.
After a few seconds Login Screen will open up.

b. Login Screen:
Option to login via User's social accounts like Facebook, Instagram, Snapchat, Twitter, Linkedin, Tumblr and Vine account.
User can also login by entering his/her e-mail id and password.
There will be a “Forgot Password” option also available:
   User will need to provide his/her registered e-mail id if this option is used to get a password reset link on the said e-mail.
After login the User will be redirected to the “Home” screen.

c. Sign Up Screen:
If User is new to the app he/she need to create an account or SignUp to the app.
Upon clicking on the Sign Up button the Sign Up option will be provided for:
   Training Seekers/Learners/Trainees
For Learners/Trainees (Users) registration, user needs to fill up the following details:
   Name
   Sex (Male/Female) (dropdown)
   Occupation
   E-Mail ID
   Contact Number
   Company Name
   Address Line 1
   Address Line 2
   City (dropdown)
   State (dropdown)
   Country (dropdown)
   ZIP Code
   Location Preference:
      Address (radio button)
      Current Location (radio button)
   Range (dropdown)
   Password
   Re-Type Password
   Accept To Terms & Conditions (checkbox)
Upon clicking on the “Register” button, a welcome mail will be sent to the registered e-mail id.
In “My Mold” screen, User needs to give some fitness related information by filling up the details given below:
   Age (DOB)
   Gender (dropdown, with radio button)
   Height
   Weight
   Hours Of Sleep Daily
   How active are you? (Very Light, Light, Moderate, Heavy) any one option can be selected.
   Eating Patterns: Under this section there will be 3 options given as below (these will display picture options of choices):
      Breakfast
      Lunch
      Dinner
   For the eating patterns (mentioned above), user will be able to choose multiple foods from the following options:
      Bacon (checkbox)
      Eggs (checkbox)
      Cheese (checkbox)
      Oatmeal (checkbox)
      Pastry's (checkbox)
      Cereal (checkbox)
      Pizza (checkbox)
      Burger (checkbox)
      Sandwiches (checkbox)
      Salads (checkbox)
      Pasta (checkbox)
      Rice (Fried Or Boiled) (checkbox)
      Chicken, Steak, Pork, Fish (Fried, Steamed, Or Baked) (checkbox)
      Fast-Food (checkbox)
      Potatoes (Fried, Steamed, Or Baked) (checkbox)
      Vegetables (checkbox)
      Other Comments (type in and app will display option). For this option, its mandatory for the user to also fill in the calorie of the food.
      Note:
      a. All the above mentioned menus will be available with calorie information.
      b. Trainee can select same food items from the menu for all the three meals. For example he/she can select Pizza for Breakfast, Dinner and Lunch.
Calorie for the food servings will be calculated and shown to the user for each food.
If user tries to input any other food other than the options, the calorie for that food has to be manually entered by the user.
Beverage Choices: This option will appear on the next screen. User can select multiple options given below (from dropdown menu) (these will display picture options of choices):
   Water (checkbox)
   Juice Soda (checkbox)
   Coffee (checkbox)
   Tea (checkbox)
   Milk (checkbox)
   Other Beverages (type in and app will display option).For this option, its mandatory for the user to also fill in the calorie of the food.
Recreational Habits: User can select multiple options from the recreational activities they are having in their free time as given below (dropdown menu):
   Playing Outdoor Games (checkbox)
   Playing Indoor Games (checkbox)
   Playing Video Game (checkbox)
   Reading Books (checkbox)
   Surfing Internet (checkbox)
   Watching Movies (checkbox)
   Sleeping (checkbox)
   Other Activities (text box)
What Stops From Working Out (dropdown menu):
   Office Timings (checkbox)
   Tiredness (checkbox)
   Household Works (checkbox)
   Not Enough Work Out Equipment's In The Place You Live(checkbox)
   Not Enough Support (checkbox)
   Don't have a Partner (checkbox)
   Other Reasons (text box)
Does Your Circle Positively Impact Your Physical Activities: User needs to select from the options given below (dropdown menu):
   Yes (radio button)
   No (radio button)
Do You Have Children: User needs to select from the options given below (dropdown menu):
   Yes (radio button)
   No (radio button)
How Do You Commute: User can select multiple options from the list given below (dropdown menu):
   Walking (checkbox)
   Car (checkbox)
   Bicycle (checkbox)
   Bus (checkbox)
   Train (checkbox)
   Bike (checkbox)
   Tram (checkbox)
   Boat (checkbox)
   Other Modes (text box)
Which Time Of The Day Do You Prefer For Exercise: User can select multiple options from the list as given below (dropdown menu):
   Morning (checkbox)
   Afternoon (checkbox)
   Evening (checkbox)
   Any Other Time (text box)
Set Your Notification Preference (dropdown menu): This question will be part of the initial (Start your Mold)
   Interested (radio button)
   Engaged (radio button)
   Fully Invested (radio button)
Any Other Thing You Like To Share With Us (text box)
Note:
a. All the above mentioned fields under Breakfast/Lunch/Dinner etc. will be managed dynamically by the Super Admin from the admin panel, which means they can be added or deleted any time
b. The list of questions set will be dynamic and will be managed by super admin.
c. User can modify the data progressively every 3 months .System will keep history of these modified records.
When user enters all the above details and submits, it will redirect him/her to the “Home” screen detailed below.

c. Slider Menu:
A hamburger menu will be provided which will consist links to the following options:
   Home
   Connections
   My Profile
   Calendar/Scheduling
   My Sessions
   My Connections
   Invite Friends
   Settings
   Contact Us
   Terms & Conditions
   FAQs
   Log Out
Clicking on any one of the above option will take the User to the respective section.

d. Home Screen:
This screen will be divided into 2 tabs “Learners/Trainees” and “Trainers”.
The “Trainee” tab will have the functionalities as given below:
   This section will consist of a list of suggested Trainee (based on the geo-location of the Trainee).
   Each suggested Trainee will have a “Connect” and “Not Interested” button. At this stage the Trainee will only able to view the basic profile information (like Profile Picture, Name and Location) of other Learners/Trainees.
   Upon clicking on the “Connect” button, a request to connect will be sent to that other User (Trainee) via notification and e-mail. The other User (Trainee) can either accept or decline the request.
   User will be able to see the list of (Trainee) who already accepted or yet to accept the invitation under the “My Connections” screen.
   After the invitation gets accepted User can chat and see profile details of other User.
The “Trainer” tab will have the functionalities as given below:
   After clicking on the “Trainer” tab, the Trainee needs to provide the information “Tell Us Your Molds/Desires”. Under this section Trainee needs to select from the options given below (dropdown menu):
      Beach Body (checkbox)
      Getting Ready for a Future Event (checkbox)
      Improve Your Physical Appearance (checkbox)
      Trim Down (checkbox)
      Other Goals (text box)
   After the User fills up the above mentioned fields he/she need to click on the “Continue” button.
   Upon clicking on the “Continue” button, a screen (“Choose Trainer”) will open with a map (by default it will show current address of the Trainee, it can be changed from the “Settings” screen) showcasing the “Trainers” around the Learner's/Trainee's location (option to choose other suggested locations (from DB) will also be there).
   User can also view a list (nearest at the first) of “Trainers” (which are showcased in the map, with a Bookmark option against each Trainer in the list), placed under the map.
   The user can switch between the map and the list view.
   Upon clicking on any “Trainer” on the list/map, the User will be redirected to the “Trainer's Details” screen, which will consist of the information as given below:
      Trainer's Name
      Trainer's Picture (including full body picture and headshot)
      Trainer's Company (this field will not be shown in case of an Individual Trainer)
      Trainer's Category (as Apprentice, Neutral, Big Leagues or Coach)
      Option to chat with the Trainer before booking
      Trainer's Contact Number
      Trainer's E-Mail ID
      Trainer's Address
      About The Trainer
      Rate per hour
      Ratings (dropdown)
      Bookmark Option: User can bookmark a particular Trainer; it will appear on the “Trainers” tab under “My Connections” screen.
      User can either “Book” or go “Back”:
      Upon clicking on the “Book” button, user will be redirected to the “Booking—Trainer” screen, where he/she needs to specify the information given below:
         Date and Time for the session (date and time selector).
         Preferred Location: User need to choose from the options given below:
         Home—Registered Address (checkbox)
         Trainer's Place—Registered Address (checkbox)
         Any Other Place (text box)
      After filling up the above mentioned fields, when user clicks on the “Send Request” button, an e-mail and push notification will go to the Trainer. The sent requests will be available to the Learners/Trainees under the “View Requests Sent” screen.
      If the Trainer accepts the request, then a confirmation will be sent to the Trainee/Learner. The approved requests from the “View Requests Sent” screen can be clicked which will be direct the User to the “Payment” screen. At any time User can click on the “Back” button to go to the “Choose Trainer” screen. The “Payment” screen will have the options given below:
         From the payment screen, user need to provide the payment details and pay the amount to confirm his/her booking. No card details will be saved in the system.
         After payment is done successfully, Trainee will get a notification message “Thank You for the Booking”, (also the Trainer will also receive a confirmation e-mail, regarding the booking details).
         Trainee can also have an option to cancel his/her Booking.
         The system will store all booking/cancellation history.
         Note:
         a. The Booking fees can be paid using the Braintree adaptive payment system. The payment can be made either by:
         i. Immediately disbursed to parties (Trainer and Super Admin) as per mentioned percentage (75% of the amount will be sent to the Trainer, while 25% of the amount will be sent to the Super Admin).
         ii. Escrow payment option.
         iii. The system will keep a track of the transaction amounts.
         b. Editing or Rescheduling/Canceling of the Booking can be done, within 15 Minutes for free. After that the Cancellation charges will be 15% of the total fees. Cancellation of booking can only be made 24 hrs prior to the scheduled appointment, after which no refund will be made by TruMold. After the cancellation amount is successfully paid, a refund request for the paid booking amount will be generated and a notification will go to the Trainer and Super Admin.
         c. The system will keep track of all the cancelled requests.
         d. In case if the Trainer cancels the booking, then the Learner/Trainee will get the refund via Escrow facility.
      If Trainee/Learner rejects the approved request from the screen “Payment” screen, the Booking request will be cancelled and a notification will be sent to the Trainer regarding the same. User will land up to the “Choose Trainer” screen again.
      In case if Trainer rejects the booking, trainee will get a notification with a message from the Trainer with the reason.
      Upon clicking on the “Back” button User will be redirected to the “Choose Trainer” screen.
      In case of a scenario where the trainee doesn't find any trainer within vicinity, then the User will get a message “Sorry, No Trainer Available. Please try again later”.
      After the Booking payment has been done successfully, the Trainee/Learner will be redirected to the “My Sessions” screen.
      After completing a session successfully, User can rate on the service.
      Note:
      a. E-Mail verification will be done on first time booking. Trainee needs to click on the e-mail verification link (which will be sent to the User's registered email ID), upon clicking the e-mail verification link the app User will get verified and proceed with the booking.
      b: There will be an “Incoming” section where a user will receive all the incoming notification. User can view details of each from each notification.

e. My Connections Screen:
This screen will be divided into 2 tabs, “Learners/Trainees” and “Trainers”:
The “Trainee” tab will have the functionalities as given below:
   This section will be divided into 3 sub-sections “Connections”, “Request Sent” and “Incoming Request”.
   The “Connections” section will show a list of Users who already accepted the Connection Request sent by the Trainee (or vice versa).
   Trainee can view profile or chat by clicking on the User in the list.
   The “Request Sent” section will show a list of Users to whom the Connection Request or app invitation is sent by the Trainee/Learner. The Connection Request and the invitation will be identified by different badges.
   The “Incoming Request” section will show a list of Users from whom the Connection Request is sent to the Trainee.
The “Trainer” tab will have the functionalities as given below:
   This screen will consist of the list of Bookmarked Trainers by the Trainee.
   Upon clicking on any “Trainer” on the list, the Trainee will redirect to the “Trainer's Details” screen, which will consist of the details/options given as mentioned in previous section.

f. Invitations Screen:
This screen will consists of various Social Media buttons (Facebook, Instagram, Snapchat, Twitter, Linkedln, Tumblr and Vine).
User need to click on any one of the Social Media button to see the list of his/her Social Media friends who are currently not into the system (or not using the app) in that particular Social Media account.
User can send single or multiple invitations (via checkbox) by clicking on the “Invite” button.
Once the Social Media Friend of the User accepts the invitation he/she will be directly added to User's Connection list and registered to the system as Trainee.
The app invitation will be sent via e-mail.

g. Calendar/Scheduling Screen:

1 After the booking, the Trainee/Learner can select multiple dates for sessions from the calendar.
For each session, user will have to choose the trainer and book the dates against him.
The calendar by default show the current month and scheduled sessions will show up in the app calendar. However, the trainee will be able to scroll across any future month and schedule sessions.
User will not be able to add schedule for previous months but only view and edit those schedules.
The app calendar will also sync to the iOS device calendar. Push/local notifications will be sent to the user before the schedule as per given in settings.
If the trainer modifies any session date or time, notification will appear to the trainee. The trainee will accept to reschedule. Once accepted, the change will reflect in the calendar as well.
Once a schedule is confirmed by the trainer ,trainee, super admin will receive an email confirming the booking.
The notification can be adjusted by the user from settings.
If the app is in the background, user can tap on notification to directly open the section in the app.

h. My Sessions Screen:
This screen will consist of all the Bookings of the User.
Each tab consist the list of the Sessions.
Upon clicking on any Session, User will be redirected to the “Session Details Page”, where he/she can able to see the following information/option:
   Trainer's Name
   Session Name
   Session Deadline
   Option To Reschedule/Cancel Booking
   Weekly Progress Report
   Back Button: Upon clicking on this button the User will be redirected to the “My Sessions” screen.
   Amount Paid For That Booking
   Time And Date Of Next And Previous Appointments
   Location For Appointment
   Rating (this option will appear if the service is completed)
   “Mark As Complete” button: Trainee/Learner need to click on this button whenever the session ends. Upon clicking on the button a notification will be sent to the Trainer and Super Admin and the payment will be released to the Trainer via Escrow facility.

i. My Profile Screen:
User can able to view and edit their personal details.
The user will be provided with an informative message of the same when filling the details. A reminder/local notification will appear to the user to modify the details (My Mold) every 3 months.
This screen will also contain general food suggestions, which will show alternate healthier food options (along with calorie information) with more nutrition value. This will be shown in a separate section of this screen. User will get notification for the suggested food items (general food suggestions, sent to all Users by system):
The User will be able to see the generalized suggestionJ,

j. Settings Screen:
Option to set location preference (address/current location) and change range.
Option to “Turn On”/“Turn Off” Invitations Notifications.
Option to “Turn On”/“Turn Off” Sessions Notification.
Option to “Turn On”/“Turn Off” Calendar Notification.

k. Contact Us Screen:
Contact Us will contain contact information to the “TruMold App”.

l. Terms & Conditions Screen:
Various Terms & Conditions will be listed here.

m. FAQs Screen:
This section will cover FAQs regarding the service.

n. Notifications:
Following notifications will be there in the app. :
   Booking Requested.
   Booking Approved/Declined.
   Payment Made.
   Scheduling/Rescheduling.
   Invitations Notification
   Generalized Food Suggestions
Reminders before a session.
2. App for Trainers Functional Requirements in Mobile Application:

a. Splash Screen:
After downloading and entering the application Users will get a Splash Screen with application title and logo.
After a few seconds Login Screen will open up.

b. Login Screen:
User need to Login by entering his/her e-mail id and password. After login the User will be redirected to the “Home” screen.
There will be a “Forgot Password ” option available on this screen:
   User will need to provide his/her registered e-mail id if this option is used to get a password reset link on the said e-mail.
Trainers cannot register directly from the application.
There will be a “Contact Us for Registration” option on this screen to allow Trainer to provide their (or Companies) details in order to register into the system.

c. Contact Us For Registration Screen:
This section will be used by trainers to contact us for registration.
User will need to select if he/she needs to register as an Individual or a Company first:
   Based on the above selection, user will need to provide information for the required fields in the respective form.
An Individual Trainer will need to provide the following details in order to register into the system:
   Name
   Picture (including full body picture and headshot)
   Upload Primary ID (both front and back image) (the IDs can be scanned copy of Passport, State ID, etc.)
   Upload Secondary ID (both front and back image) (the IDs can be scanned copy of Passport, State ID, etc.)
   Contact Number
   E-Mail
   Address Line 1
   Address Line 2
   City (dropdown)
   State (dropdown)
   Country (dropdown)
   ZIP Code
   Range (dropdown)
   About
   Category: User needs to select the option given below (from dropdown menu):
      Apprentice (radio button)
      Neutral (radio button)
      Big Leagues (radio button)3
      Coach (radio button)
   Company Associated With (optional) User can provide the name of the Company he/she is associated with
   Note: The ID's cannot be modified later by the user.
A Company will need to provide the following details in order to register into the system:
   Company Name
   Contact Person Name
   Upload Primary ID (both front and back image) (the IDs can be scanned copy of Passport, State ID, etc.)
   Upload Secondary ID (both front and back image) (the IDs can be scanned copy of Passport, State ID, etc.)
   Contact Number
   E-Mail ID
   Website
   Address Line 1
   Address Line 2
   City (dropdown)
   State (dropdown)
   Country (dropdown)
   ZIP Code
   Subscription Amount
   Range (dropdown)
   About
   Note: The ID's cannot be modified later by the user.
When users submits the details:
   The submitted details will be listed in a separate module in the “Super Admin Panel”.
   Upon approval (approx time for approval will be 72 hours) from the “Super Admin” a User can login as Individual/Company.
   The “Super Admin” will provide a random password after approval, which User will have to change during first time login.
   User can use the system free for 60 days and after that he/she needs to pay $ 3.99/month.
   The Trainer need to pay the subscription amount upon their first login to continue using the system.
   Super Admin will have the rights to provide/block access of any user.

d. Slider Menu:
A hamburger menu will be provided which will consists to the following options:
   Home
   My Profile
   My Sessinnc
   My Learners/Trainees
   Settings
   Contact Us
   Terms & Conditions
   FAQs
   Log Out
Clicking on any one of the above options will take the User to the respective page.

e. Home Screen:
A list of pending requests will be there, with a “Accept” and “Decline” against each response:
   Upon tapping on the “Accept” button the User will land up to a “Respond to Request” screen. This screen will contain the details of the request as given below:
      Learner's/Trainee's Name
      Learner's/Trainee's Contact Number
      Learner's/Trainee's E-Mail ID
      Appointment Location
      Appointment Date & Time.
      Estimated Price: It will be automatically calculated based on the rates that are inserted by the “Admin” from the backend, along with a “Send / Submit” button:
         Upon clicking on the “Send/Submit” button, the price will be sent to the Trainee.
         When the Trainee accepts or deny the quote a notification will be prompted.
   Upon tapping on “Decline” button a comment box will open up (where Trainer needs to mention the reason of deny, upon clicking on the send, a notification will go to the Trainee.
   On tapping against any response in the list, the Trainer will land up to the “Booking Details” page, where he/she can able to see the details:
      Learner's/Trainee's Name
      Learner's/Trainee's Contact Number
      Learner's/Trainee's E-Mail ID
      Appointment Location
      Appointment Date & Time
      Learner's/Trainee's Address & Location
      Learner's/Trainee's Gender
      Learner's/Trainee's Occupation
      Learner's/Trainee's Height
      Learner's/Trainee's Weight
      Learner's/Trainee's Food Patterns
      Learner's/Trainee's Consumption Of Types Of Meals
      Learner's/Trainee's Goals
      Learner's/Trainee's Recreational Habits
      What Stops The Trainee From Working Out
      Does Learner's/Trainee's Circle Positively Impact His/Her Activities
      How Do The Trainee Commute
      Which Time Of The Day Do The Trainee Prefers For Exercise
      “Accept” “Decline” button:
         Upon tapping the user will land on the “Accept” button the User will land up to a “Respond Request” screen.
         Upon tapping on “Decline” button a comment box will open up (where

Trainer needs to mention the reason of deny, upon clicking on the send, a notification will go to the Trainee.
Each booked Session will be saved in the “My Sessions” screen.
Note: The Booking fees can be paid using the Braintree adaptive payment system. The payment can be made either by:
a. Immediately disbursed to parties (Trainer and Super Admin) as per mentioned percentage (75% of the amount will be sent to the Trainer, while 25% of the amount will be sent to the Super Admin).
b. Escrow payment option.
c. The system will keep a track of the transaction amounts.

f. My Profile Screen:
User can able to see and edit following details:
   Name
   View Primary ID (both front and back image) (the IDs can be scanned copy of Passport, State ID, etc.)
   View Secondary ID (both front and back image) (the IDs can be scanned copy of Passport, State ID, etc.)
   Contact Number
   E-Mail ID
   Address Line 1
   Address Line 2
   City
   State
   Country
   ZIP Code
   Website (in case of Company)
   Company Name (in case of Company)
   Contact'Person Name (in case of Company)
   About
   Password

g. My Sessions Screen:
This screen will consist of all the Bookings of the User Separated under 2 tabs “Past Sessions” and “Current Sessions”.
Each tab will consist of the list of the Sessions.
Upon clicking on any Booking, User will be redirected to the “Booking Details Page”, where he/she can able to see the following information/option:
   Sessions List: Upon clicking on any Session User will be redirected to the “Sessions Details” page, where he/she can be able to see the following information:
      Learner's/Trainee's Name
      Session Name
      Deadline
      Option To Reschedule/Cancel Booking
      Weekly Progress Report
      Back Button: Upon clicking on this button the User will be redirected to the “My Sessions” screen.
   Amount Paid For That Booking
   Time And Date Of Next And Previous Appointments
   Location For Appointment
   Rating (this option will appear if the service is completed)
   “Mark As Complete” button: Trainer need to click on this button whenever the session ends. Upon clicking on the button a notification will be sent to the Trainee/Learner and Super Admin. Upon the Trainee's/Learner's approval the money will be transferred to the Trainer.
Note: If the Trainer cancels the booking, then the Learner/Trainee will get the refund via Escrow facility.

h. My Learners/Trainees Screen:
The user will be able to view a list of all Learners/Trainees who are in training or had trained under the trainer.
The trainer will also be able to view respective details (profile, schedule) for the trainee by tapping from the list.

i. Calendar/Scheduling Screen:
The trainer will be able to see all the current schedules and appointments in the calendar section.
The trainer will receive a notification if any trainee books schedule. The trainer must accept it to show up in the calendar.
If a Learner's/Trainee's schedule overlaps with the trainers existing schedule, the user will be prompted to continue or decline schedule.
If user chooses to continue the schedule will get attached to the calendar. If user chooses to decline, an option to reschedule will appear. The trainer will also be able to reschedule each session directly from the calendar.
The calendar by default show the current month and scheduled sessions will show up in the app calendar. However, the user will be able to scroll across any future month and schedule sessions.
If the trainer modifies any session date or time, notification will be sent to the trainee. Once the trainee accepts the change, the trainer will be notified and the session will get scheduled in the calendar.
Once a schedule is confirmed, the trainer ,trainee, super admin will receive an email confirming the booking.
User will not be able to add schedule for previous months but only view and edit those schedules.
The app calendar will also sync to the iOS device calendar. Push/local notifications will be sent to the user before the schedule as per given in settings.
The notification can be adjusted by the user from settings.
If the app is in the background, user can tap on notification to directly open the section in the app.

o. Settings Screen:
Option to set range.
Option to mark as “Available”/“Not Available”.
Option to “Turn On”/“Turn Off” Learners/Trainees Notifications.
Option to “Turn On”/“Turn Off” Calendar Notification.
Note: If the Trainer marks himself/herself as “Not Available” then his/her name will not be shown in the Learner's/Trainee's section of the app.

j. Contact Us Screen:
Contact Us will contain contact information to the “TruMold App”.

k. Terms & Conditions Screen:
Various Terms & Conditions will be listed here.

l. FAQs Screen:
This section will cover FAQs regarding the service.

m. Notifications:
Following notifications will be there in the app:
   Booking Requested.
   Quote Accepted/Rejected.
   Scheduling/ Rescheduling
   Reminders before a session.
   Subscription Date Reminder (1 day before subscription ends)
   Booking Confirmation by the Trainee.
   Booking Amount Received.

Individual Trainer Admin—Web Based Admin Panel

Individual Trainer (who is not working under a Company) will be able to login to a Web Based

Admin panel to manage the following modules:

1. My Profile Module:
The Individual Trainers will be able to manage the following profile details from this module:
   Name
   Picture (including full body picture and headshot)
   View Primary ID (both front and back image) (the IDs can be scanned copy of Passport, State ID, etc.)
   View Secondary ID (both front and back image) (the IDs can be scanned copy of Passport, State ID, etc.)
   Contact Number
   E-Mail ID
   Address Line 1
   Address Line 2
   City
   State
   Country
   ZIP Code
   Range
   About
Trainer can also manage his/her bank account details from this module. The account details will be integrated with Braintree adaptive payment system from the backend.
   Note: The server needs to be PCI compliant for this.
Admin can manage his/her subscription from this module. Admin can renew subscription if required.
The Trainer will be auto charged after the subscription Session ends.
Note:
a. The subscription will be done after the request for registration will be approved by the Super Admin. On approval from the Super Admin the User need to pay via Payment Gateway after their first time login into the system (from web).
b. The payment gateway used should support this auto deduction feature (for subscription renewal). Braintree also offers this option under recurring billing.
c. If the transaction is not possible (for any reason) a notification e-mail will be sent to both Trainer and Super Admin and the Company/ Individual Trainer status will change to non-subscribed.

2. Learners/Trainees Module:
Admin can manage (add/edit/delete) Learners/Trainees.
Admin will be able to see the information of the Trainee as given below:
   Learner's/Trainee's Contact Number
   Learner's/Trainee's E-Mail ID
   Appointment Location
   Appointment Date & Time (list of previous and future appointments, only for paid Learners/Trainees)
   Current Session Ongoing Including The Progress Made By Each Trainee (only for paid Learners/Trainees)
   Amount Paid For The Booking (only for paid Learners/Trainees)
   Learner's/Trainee's Address & Location
   Learner's/Trainee's Gender
   Learner's/Trainee's Occupation
   Learner's/Trainee's Height
   Learner's/Trainee's Weight
   Learner's/Trainee's Food Patterns
   Learner's/Trainee's Consumption Of Types Of Meals
   Learner's/Trainee's Goals
   Learner's/Trainee's Recreational Habits
   What Stops The Trainee From Working Out
   Does Learner's/Trainee's Circle Positively Impact His/Her Physical Activities
   How Do The Trainee Commute
   Which Time Of The Day Do The Trainee Prefers For Exercise
Admin will also be able to see the Learner's/Trainee's Payment Status and the details of the Trainee who contacted them for a quote (and can respond to them).
Admin will get a notification for each Booking.
Admin will be able to see the ratings given by each Trainee.

3. Calendar Module:
This will be a simple view section for the users about the session schedules.

4. Rates Module:
From this module Admin will be able to define the service rates that the Trainer will be charging from the Learners/Trainees for each Booking.
When displaying the rates to the user, 15% will be added to this and shown.

5. Reports Module:
From this module Individual Trainer can generate the following types of report for a set time frame:
   Transactions History (filtered by Trainee and date).
   Filtered Transactions as per Individual Services (filtered by Trainee and date).
   Booking History (filtered by Trainee and date).
The reports will be generated in .PDF format.

Company Admin—Web Based Admin Panel

Company Admin will be able to login to a web based Admin panel to manage the various Trainers, their details and subscription under them. Company referred to an organization under which multiple Trainers are there.

1. Company Profile Module:
The Admin will be able to manage the following profile details from this module:
   Company Name
   Contact Person Name
   View Primary ID (both front and back image) (the IDs can be scanned copy of Passport, State ID, etc.)
   View Secondary ID (both front and back image) (the IDs can be scanned copy of Passport, State ID, etc.)
   Contact Number
   E-Mail ID
   Address Line 1
   Address Line 2
   City
   State
   Country
   ZIP Code
   About
   Website
Admin can renew subscription if required from this section.
Company can also manage their bank account details from this module. The account details will be integrated with Braintree adaptive payment system from the backend.
The Trainer will be auto charged before or after the subscription Session ends as per the rule defined in the programming logic.
Note: Trainer and Super Admin and the Company status will change to non-subscribed or temporary disabled.

2. Learners/Trainees Module:
Admin can manage (add/edit/delete) Learners/Trainees.
Admin will be able to see all the information of the Learners/Trainees.
Admin will also be able to see the Learner's/Trainee's Payment Status and the details of the Learners/Trainees who contacted them for a quote (and can respond to them).
Admin will get a notification for each Booking.
Admin will be able to see the ratings given by each Trainee.

3. Company Trainers Module:
From this module Admin will be able to manage (add/edit/delete) the Trainers under the Company.
Admin will be able to provide access or block Individual Trainer from this module.
Admin will be able to view the services (for example, Bookings and ratings).
Admin will be able to add/view/edit new Trainer providing the following details:
   Name
   Category: User needs to select the option given below (from dropdown menu):
      Apprentice (radio button)
      Neutral (radio button)
      Big Leagues (radio button)
      Coach (radio button)
   E-Mail ID
   Contact Number
   Address
   Login & Password

4. Calendar
This will be a simple view section for the users about the session schedules.

5. Rates Module:
From this module the Company Admin or an individual will be able to define the service rates that the Trainer will be charging:
   Each trainer would have his/her own rate and that can be set by the company admin.

6. Reports Module:
From this module Individual Trainer can generate the following types of report for a particular time frame:
   Transactions History (filtered by Trainee and date).
   Filtered Transactions as Per Individual Services (filtered by Trainee and date).
   Booking History (filtered by Trainee and date).
The reports will be generated in .PDF format.

Super Admin—Web based Admin Panel

Super Admin will be able to login to a web based Admin panel to manage the various Companies, Individual Trainers and generate reports.

1. Trainers (Company) Module:
From this module Super Admin will be able to manage (add/edit/delete) the Companies that are registered into the system.
Super Admin will be able to view and approve new registration requests from this module:
   Super Admin will have to contact the Companies and manually add them into the system.
A list of Companies who have been registered into the system will be shown in this module.
Super Admin can view all the Company related details by tapping on a particular Company.
Super Admin can block a particular Company if required:
   The associated Trainers will not be able to access the application if the Company is blocked.
Super Admin can view the subscription status of each Company from this module.
From this module Super Admin will be able to manage the subscription rate structure for the Companies:
   Any changes made to the subscription rates will not apply on current subscription Session of the Companies; it will be applied from the next Session.
   Super Admin can define the following:
      Subscription: The cost and period will be defined by the Super Admin.
      Per Transaction Rate: This is the rate which will be payable by the Company to the Super Admin for each transaction made by the customer.
Super Admin will be able to define the subscription rates and period for individual trainers or companies.

2. Trainer (Individual) Module:
This module will show a list of Individual Trainers who are registered into the system.
Super Admin will be able to view and approve new registration requests of the individual trainers from this module:
Super Admin will have to manually add them into the system.
Super Admin can block a particular Trainer from this module if required. Super Admin can view transactions made by each Trainer. This could include the following details:
   Trainer Charges: With option to view Individual service charge levied by the Trainer (Booking charge).
   Application Fee: This is the charge/fee levied by the system on the Trainer against each transaction.
   Note: We assume that the used will be Braintree adaptive payment system
Super Admin will be able to define the percentage of charge that he/she wants each Individual Trainer under the Company to pay.

3. Learners/Trainees Module:
This module will show a list of registered Learners/Trainees.
Super Admin will be able to view Trainee details and transaction history from this module.
Super Admin will be able to block/unblock Individual Trainee if required.
Super Admin will be able to manage (add/edit/delete) all the fields in the “Sign Up” screen (for example, Learner's/Trainee's Food Patterns, Learner's/Trainee's Consumption Of Types Of Meals, Learner's/Trainee's Goals, Learner's/Trainee's Recreational Habits, etc., which are reflected on the Learner's/Trainee's App end).
Super Admin will be able to manage (add/edit/delete) the list of food items along with their calorie value for breakfast, lunch, dinner and beverages.
Super Admin will be able to send generalized food suggestions to the all Trainee (Learners);

4. Reports Module:
From this module Super Admin will be able to generate the following types of report:
   Subscription status of the Trainers along with subscription amount (filtered by date).
   Sum total transaction from Individual Companies in a given time frame (filtered by date).
   Sum total transaction from Individual Trainers in a given time frame (filtered by date).
   Sum total transaction from Individual Trainee in a given time frame (filtered by Trainee and date).
Reports will be generated in a .PDF format.

Testing During Development Period

During the course of the development period and further update situations, constant quality based testing will be carried out in order to assist the core developers to deliver error free deliverables each time. This will be taken care of, by efficient and professional testing team members.

iOS based test builds are sent via the ad-hoc provisioning method. While we could provide one device for testing, we strongly advise clients to have their developer account ready so that could setup as many testers as they want. In case of any update, a separate effort and cost for this will be provided on review of the upgrade/update.

Important Note
1. App Users must have their GPS service turned on to use this application.
2. Clients are expected to:

Review documents and provide feedback.

Provide feedback promptly (next day at the latest to maintain the schedule).

Be upfront about expectations.

Be involved in review, testing and feedback.
3. Changes requested by client are handled via change request management. When a new requirement which is out of scope is made, we will review the requirement and then define what is needed and how it will impact the overall app/game. Once agreed we provide an estimate of the time required to get it done. On approval from the client the change request is taken up and charged on our hourly estimate at $20/hr.
4. Integration of third party APIs & client provided APIs are defined as per the last reviewed documents and understood functionality of the API. In case there is any change in the API after the review and agreed scope, we will not be able to guarantee the working of the function/s associated with the API. If possible, we will make the corresponding updates to our system code needed to work with the updated API. This will be charged extra on an hourly basis.
5. We assign a Project Manager to interact with the client and he/she will be responsible for all aspects of the project at our end.
6. Client will provide the store accounts for provisioning (testing) and submission.

For iOS, you need to register with developer.apple.com and it costs $99.

Queries and Assumptions
We assumed that in case if the Trainer cancels the booking, then the Learner/Trainee will get the refund via Escrow facility.
Please confirm if the Trainer's App will have same functionalities (like send/receive requests among Trainers and Learners/Trainees) as the Learner's/Trainee's app.
We are assuming that User (Trainee) will be able to modify the following data once in 3 Months:

Height

Weight

Hours Of Sleep Ddily

Eating Patterns

Beverage Choices

Recreational Habits

Does Your Circle Positively Impact Your Physical Activities

Do You Have Children

How Do You Commute

Which Time Of The Day Do You Prefer For Exercise
We are assuming that ‘Food suggestion’ (list of mapping of alternate foods on the existing options) will be provided by client.
Do we require these questions for a trainee?

Marital Status Of The Trainee

How Many Children Does Trainee Have
Reports cannot be generated from the mobile application. (Please confirm the reports)
For Reports kindly refer to the sections given below:

For Individual Physical Trainers: “4. Reports Module”.

For Company Physical Trainers: “5. Reports Module”.

For Super Admin: “5. Reports Module”.

What happens to the 15% charged for cancellation?

### Suggestions

It would be very efficient way of handling the bookings, schedules and appointments for all the users by maintaining them in a ‘Calendar’ section. This section will give a visual appeal and will also use to provide notifications by the device.
The calendar can also be used by the users to add their own appointments outside the app.
Rescheduling and overlapped sessions can be efficiently handle through the calendar functionality.
Braintree is the adaptive system which will enable the payment system to be adjusted based with options mentioned above as per needs of TruMold.
If the user wants to cancel a booking in between, it would be best to provide some option of books, sample exercises or information to retain interest of the user before taking him back to the previous screen.

### Time Estimation

The time estimation will be provided on confirmation of the detailed scope of work.

A) (canceled)

B) (canceled)

C) (canceled)

D) (canceled)

E) (canceled)

F) (canceled)
